(19) United States
(12) Patent Application Publication
(10) Pub. No.: US 2002/0123901 A1
(43) Pub. Date: Sep. 5, 2002

(54) Behavioral compiler for prioritizing network traffic based on business attributes

(76) Inventors: Luc Nguyen, Atlanta, GA (US); Donald G. Workman, Alpharetta, GA (US); Joseph Yannaccone, Hialeah, FL (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/970,386

(22) Filed: Oct. 2, 2001

Related U.S. Application Data
(60) Provisional application No. 60/237,146, filed on Oct. 2, 2000.

(51) Int. Cl. G06F 17/60

(52) U.S. Cl. 705/1

(57) ABSTRACT

A method of prioritizing network traffic demands based on business criterion and attributes. The method has an initialization step wherein the user selects a plurality of business attributes and then creates a formula based on the attributes and criterions to provide relative priority values based on revenues issues associated with the network. Following initialization, steps run asynchronously including automated steps of collection of values related to the attributes selected, and calculation of priority values for demands utilizing the equation and the data collected.

### BACKGROUND OF THE INVENTION

The Internet is growing at exponential rates. Competition is coming from both traditional service providers and unconventional but well funded startups. As one skilled in the art is aware, the Internet was designed as a DARPA project in the 1950's. Its distributed routing architecture allowed it to function in case of nuclear disaster or other catastrophic events to the network. This best effort routing has served us well for its intended purposes. However, as customers started to rely on the Internet for their mainstream businesses, this technology became inadequate.

In spite of that, service providers today are entering into contracts with their largest customers in the form of Service Level Agreements (SLAs) and are promising better services for their customers' business.

SLAs typically guarantee a certain level of service. Failing that the customers either receive a refund, do not have to pay, or even receive a penalty payback from the service providers. These refunds and paybacks are expenses for the service providers. Current technologies do not offer a method to enforce these guarantees provided in SLAs. Network failures and congestion are common due to unpredictability of the traffic. To combat this, service providers are typically overbuilding their networks to ensure the SLAs can be met. However, this approach is costly and still does not provide the adequate assurance that the SLAs can really be met. SLA's have become legal contracts with no way to technically force the adherence to them.

With these SLAs, the business side of service providers understand that not all customers' data are of equal values and that some data should be treated differently as it carries a higher value or cost. In case of congestion, the data should be routed based on business objectives rather than technical objectives.

Therefore there is a need for providers to be able to prioritize network traffic based on network contracts and other pertinent agreements, needs and desires.

### SUMMARY OF THE INVENTION

Stated generally, the present invention comprises a process and system for compiling a set of business criteria into usable metrics for dynamically prioritizing a set of traffic demands. A traffic demand (hereinafter a “Demand”) is a unidirectional communication need or requirement between exactly two points in the network. The level of granularity for distinguishing between two Demands may vary to be as granular as per flow or as smooth as per range of source addresses. A Demand can also be thought of as a requirement for a certain amount of bandwidth to be reserved between an originating and a terminating node in a network.

One skilled in the art will appreciate that two Demands flowing in opposite directions between the same two points may be paired together to create a bi-directional service.

The Behavioral Profile Compilation is a process for compiling a set of business criteria into usable metrics for dynamically prioritizing a set of Demands. This prioritization can be done for any number of reasons and based on any number of attributes and/or criterion.

A Behavioral Profile is a set of attributes which is used by a particular instance of a Behavioral Profile Compilation. The purpose of the Behavioral Profile is to allow business strategists to prioritize demands based on their unique set of business attributes. This creates a real-time direct connection between business strategy and demand priority that can support continuously changing business conditions and objectives.

As shown in FIG. 1, which depicts an overview of Behavior Profile Compilation Process 100. The process is designed to allow for prioritization of demands based on business attributes associated with the demands. Behavior Profile Compilation Process 100 involves 5 distinct steps:

First Step 110, of defining a set of quantifiable business criteria upon which prioritization decisions should be based;

Second Step 120 of defining a mathematical formula to evaluate the various attributes and criteria together;

Third Step 130 for each criterion of each Demand, collect current values from a data store;

Fourth Step 140 for each Demand generate a Priority, utilizing the formula generate in the second step 120 as discussed above. The Priority for each Demand represents its importance, relative to other Demands, based on business criteria.

Fifth Step 150 to store results of priority calculation in database to allow other systems to access and utilize the results.

Thus it is a feature of the present invention to allow prioritization of Demands.

It is another feature of the present invention to provide the ability for business strategists the ability to prioritize Demands based on the strategist's particular set of business attributes.

It is yet another feature of the present invention to provide the ability assign Priorities to Demands.

Other objects, features, and advantages of the present invention will become apparent upon reading the following specification, when taken in conjunction with the drawings and the appended claims.

### BRIEF DESCRIPTION OF THE DRAWINGS

FIG. 1A is a general depiction of the invention in the form of an exemplary embodiment.

FIG. 1B is an depiction of an overview of the Behavior Profiler Compiler in the form of an exemplary embodiment.

FIG. 2A is a depiction of an exemplary embodiment of the User Operations and Autonomous Operation aspects of the Behavior Profiler Compiler.

FIG. 2B is a further depiction of an exemplary embodiment of the User Operations and Autonomous Operation aspects of the Behavior Profiler Compiler.

FIG. 2C is a depiction of an exemplary embodiment of criterions and their respective weightings.

FIG. 2D is a depiction of an exemplary embodiment of the Autonomous Operation.

FIG. 2E is a depiction of an exemplary embodiment of the Behavior Profile Compiler.

FIG. 3A is an exemplary depiction of a calculation of various Demand's weighted value based on various hypothetical criterions on a first hypothetical network's.

FIG. 3B is an exemplary depiction of a calculation of various Demand's weighted value based on various hypothetical attributes on a second hypothetical network's.

FIG. 4A is an exemplary depiction of a Graphical User Interface (GUI) device window to provide entry of attributes into the Behavior profiler.

FIG. 4B is an exemplary depiction of a Graphical User Interface (GUI) device window to provide entry of formulas into the Behavior profiler.

FIG. 5A is an exemplary depiction of an XML script as another method to provide entry of attributes into the Behavior Profiler.

FIG. 5B is an exemplary depiction of an XML as another method to provide entry of formulas into the Behavior Profiler.

FIG. 6 is a sample listing of exemplary possible attributes that can be utilized in the present invention as attributes or as criterion.

FIG. 7 is another depiction of an exemplary embodiment of the present invention.

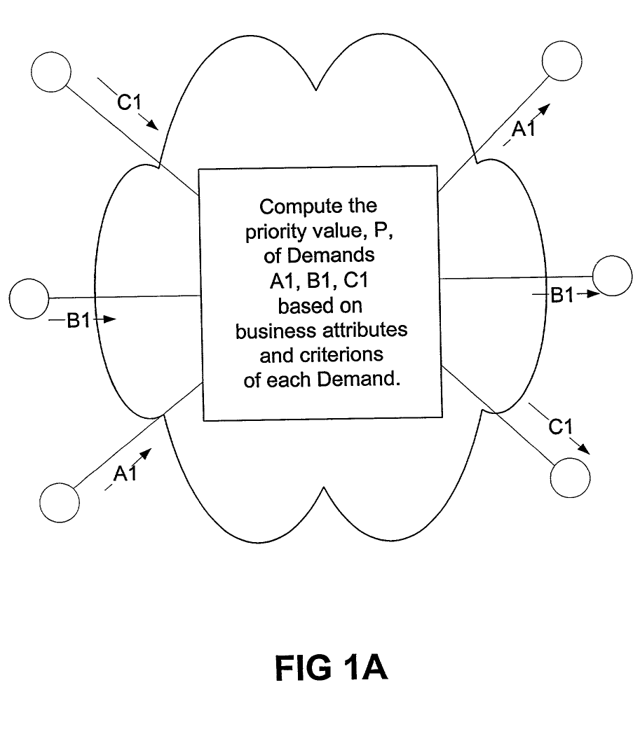

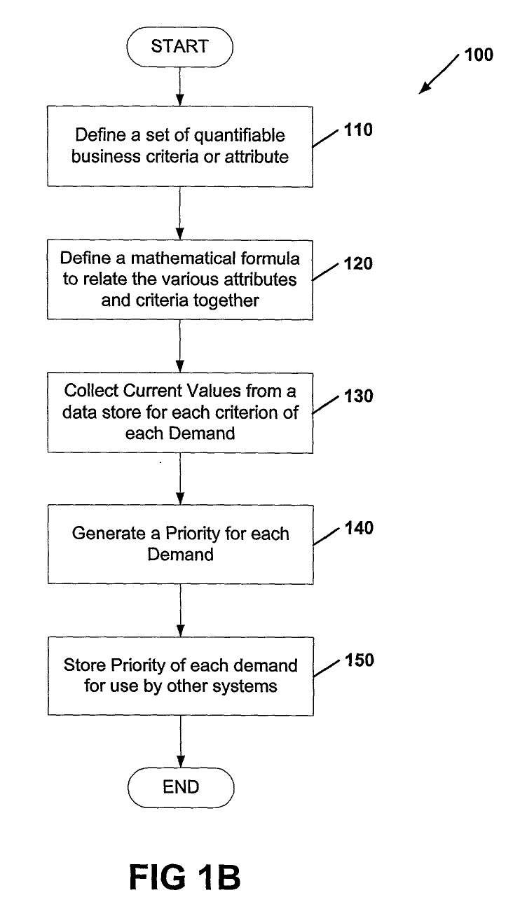

### DETAILED DESCRIPTION OF THE DISCLOSED EMBODIMENT

### I. An Exemplary Embodiment

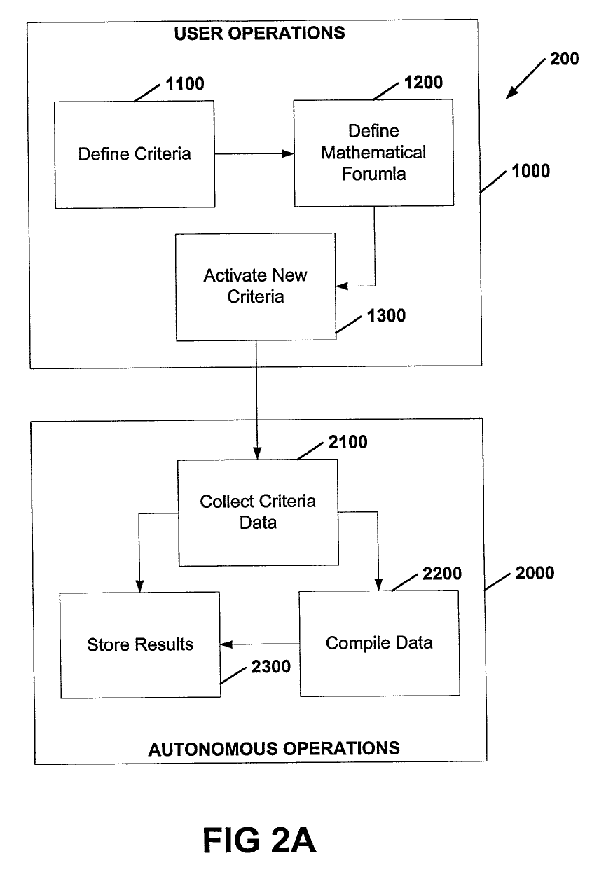

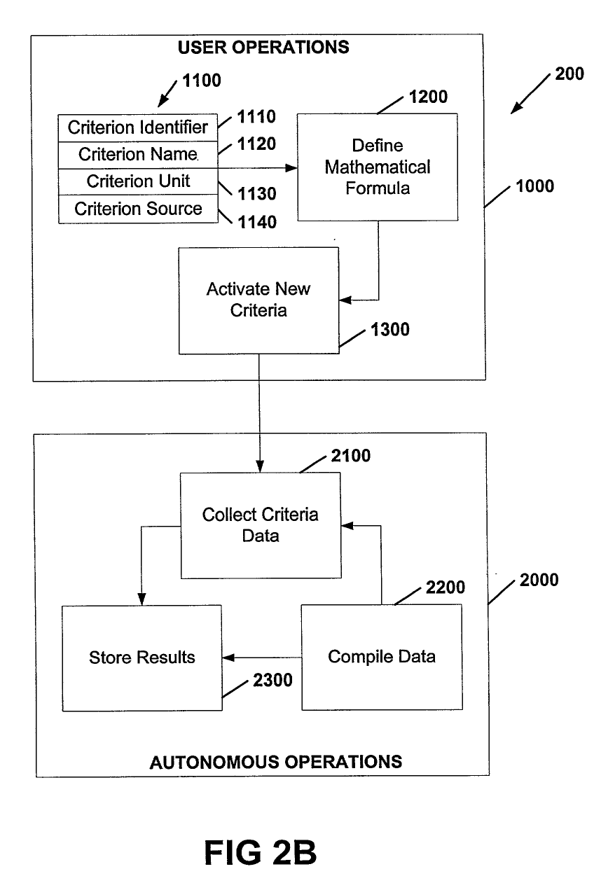

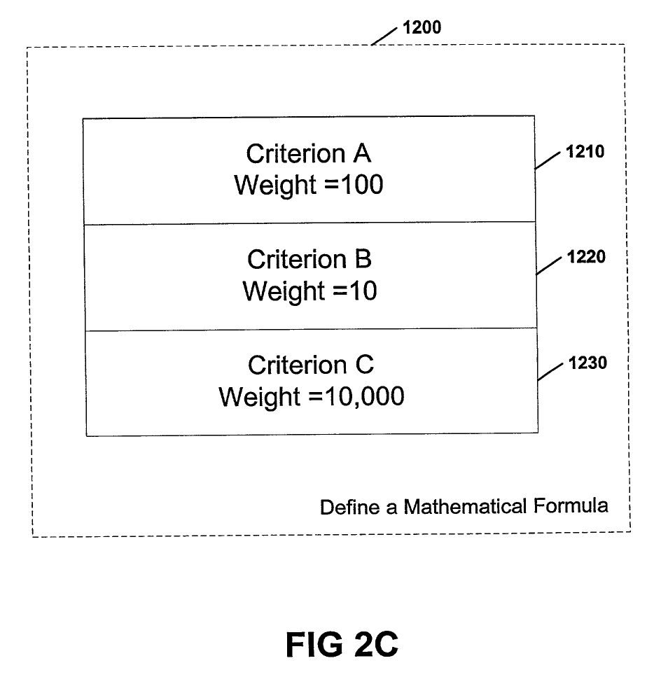

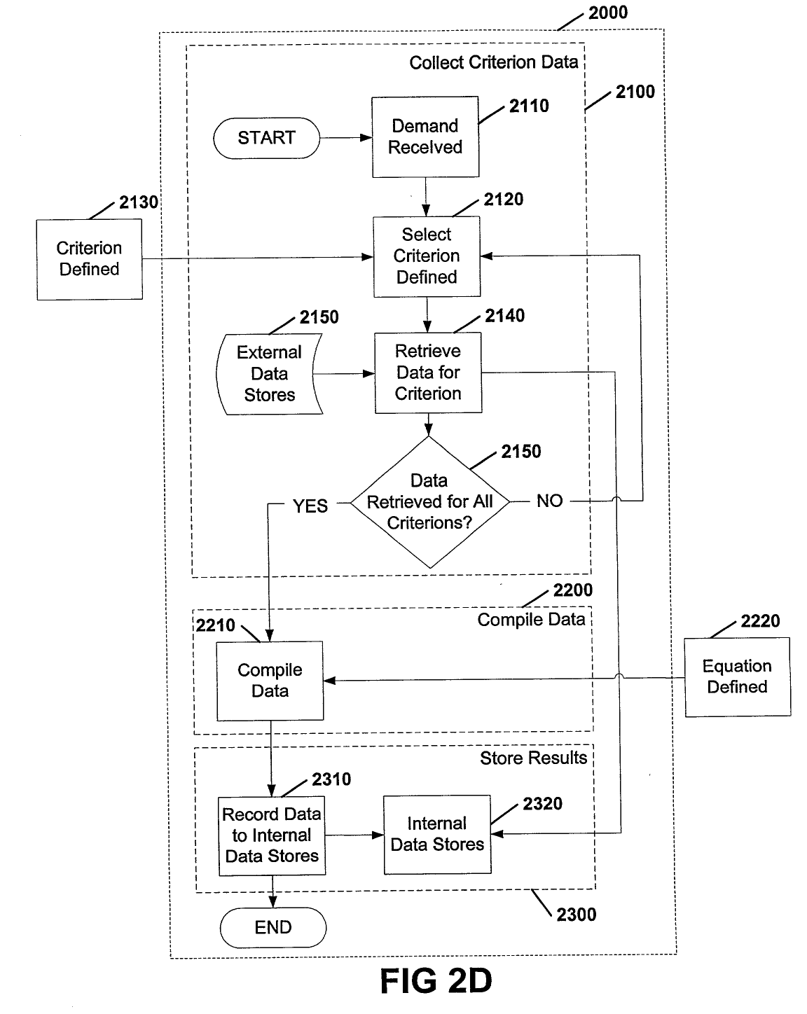

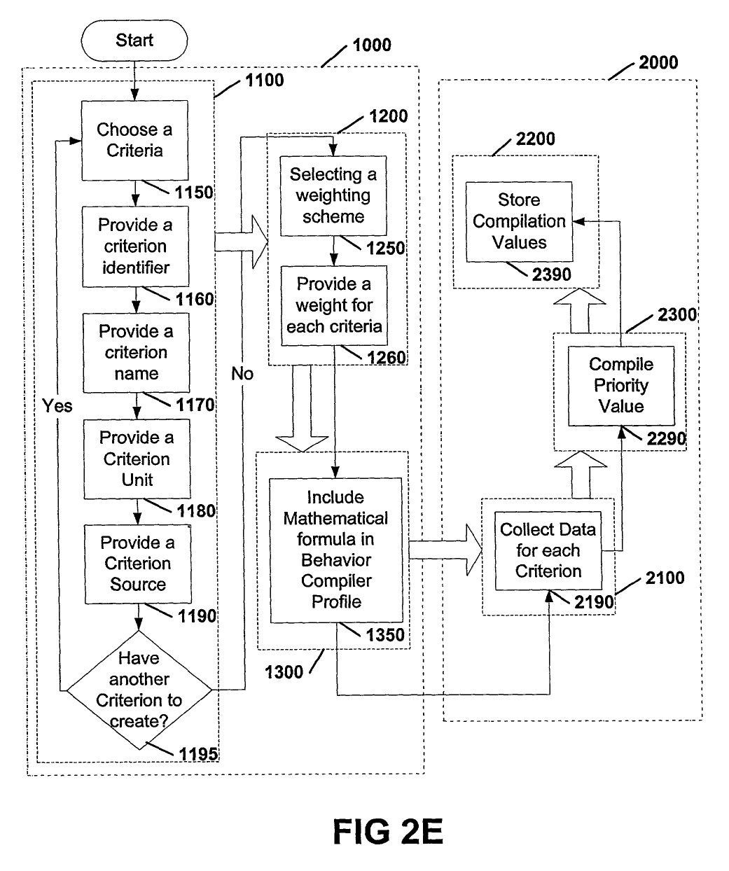

Referring now to the drawings, in which like numerals indicate like elements throughout the several views, the present embodiment of a Behavioral Profiler 200 has two distinct groups of operations. Turning to FIG. 2A we see that these two group are User Operations 1000 and Autonomous Operations 2000. User Operations 1000 initializes Behavioral Profiler 200, but following initialization both groups are contemporaneous to one another and run asynchronously.

### I.A. User Operations

As shown in FIG. 2A, User Operations 1000 preferably comprise Define Criteria 1100, Define Mathematical Function 1200, and Activate New Criteria 1300.

### I.A.1. Defining of Criteria

As shown in FIG. 2B, a valid Defined Criteria 1100 can be any user defined, quantifiable business metric that can be directly associated with a given Demand. A criterion preferably has four key elements: (1) Criterion Identifier 1110, (2) Criterion Name 1120, (3) Criterion Unit 1130 and (4) Criterion Source 1140.

Preferably, Criterion Identifier 1110 is a number that is sequential to a prior Criterion Identifier 1110. If no prior Criterion Identifier 1110 exist, it is preferable to start at the number one. Criterion Identifier 1110 uniquely identifies a given criterion.

Criterion Name 1120 is preferably a “human-language” title assigned to a criterion for the purpose of functional human reference. It is preferred that a criterion name provide some indication of the type of data the criterion would represent. For example, if the criterion is the amount earned, “Revenue” would be an appropriate name.

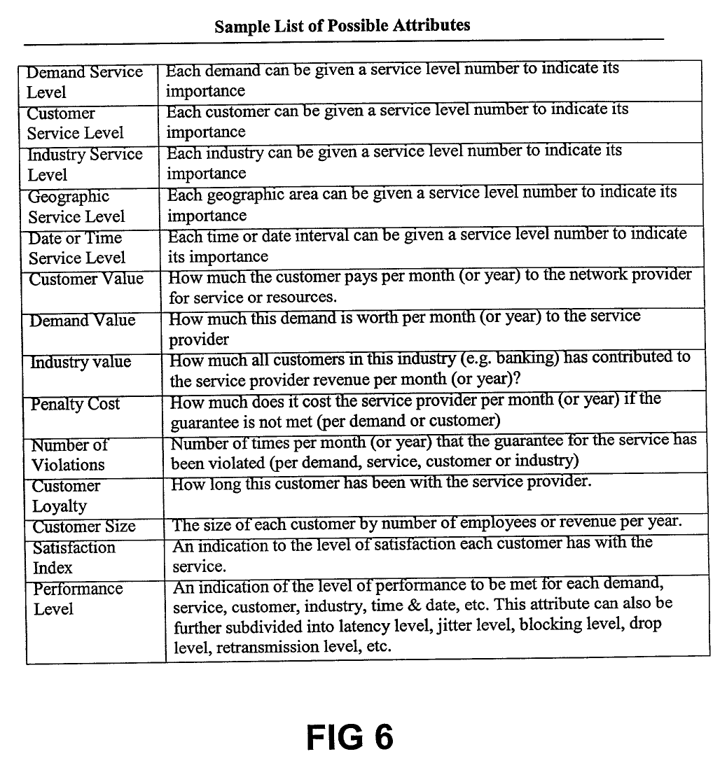

Turning to FIG. 6, which provides a sample list of attributes, but can and should be used as possible criterions.

In this present application the term criterion and the term attribute are synonymous with each other and are and should be used interchangeably.

Criterion Unit 1130 is the unit of measurement for the value to be collected and associated with a particular criterion. The purpose of the criterion unit is to provide a means to normalize a wide range of criteria that may be represented by values that are orders of magnitude apart. Normalization will prevent any particular criterion from becoming negligible prior to weighting and compilation.

Criterion Source 1140 is the location of associated values either in an internal or external data store. The criterion source is used by autonomous mechanisms to collect values for each criterion of each Demand.

There is no limit to the number of criteria that may be defined for a given Behavioral Profile beyond that of the practical limitations of the hardware and software used for computation and storage.

### I.A.2. Define Mathematical Formula

A mathematical formula is any valid formula that the user can create to relate the various attributes together. The purpose of the formula is to allow the user to define the priority or importance of one demand verses another using any or all of the attributes or criteria available.

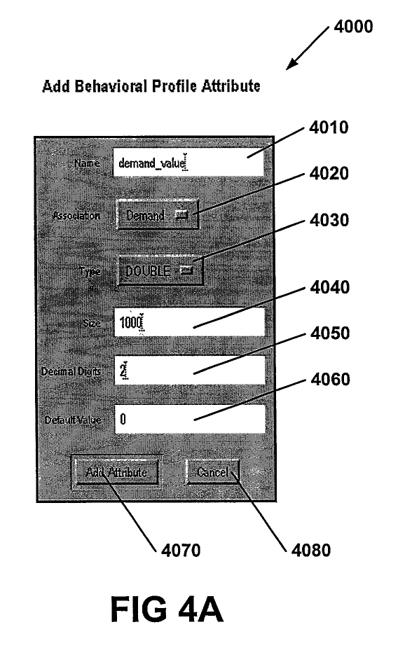

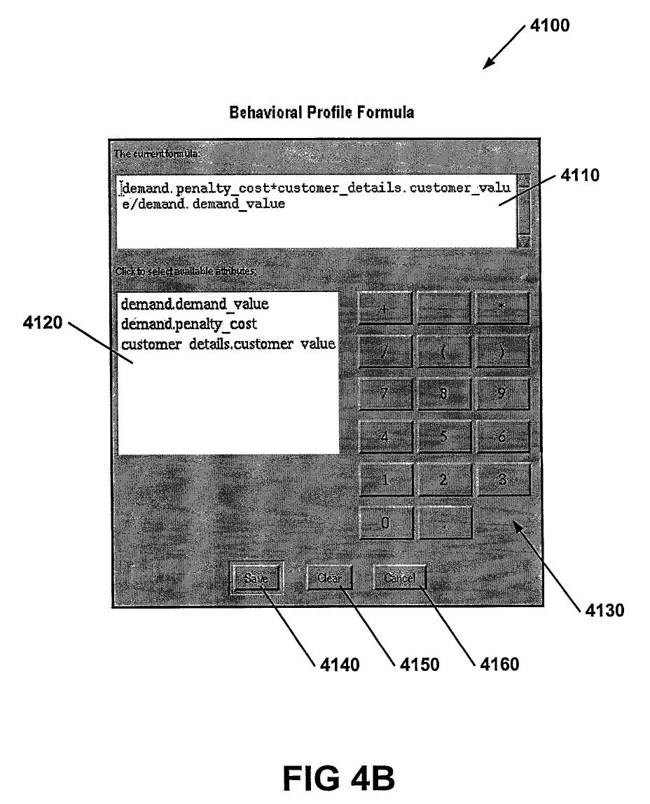

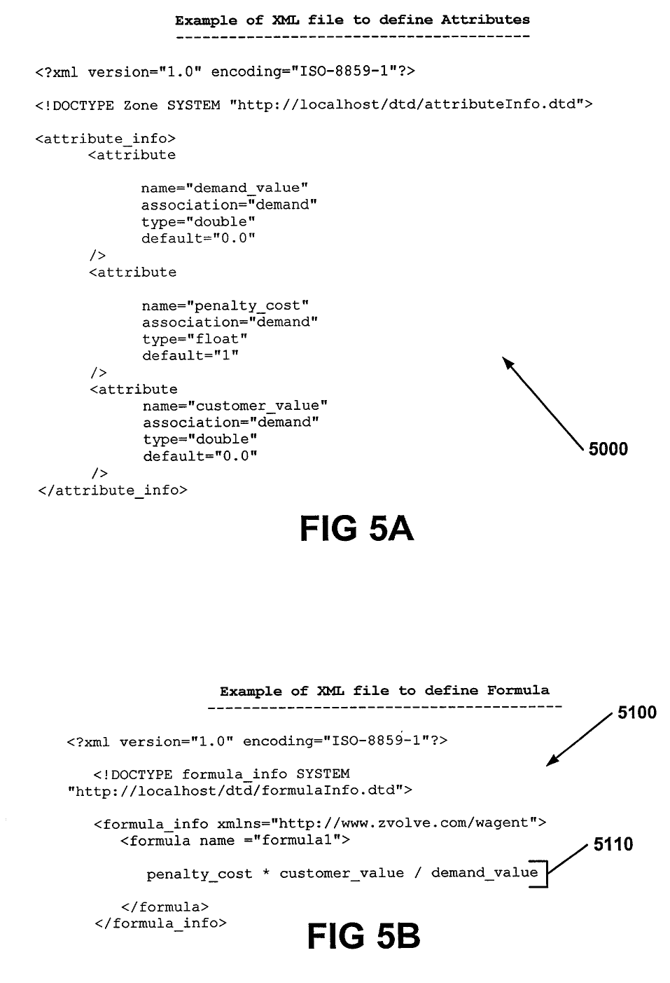

Turning to FIG. 4B, which depicts an exemplary embodiment for formula entry 4100, an example formula 4110 is shown. Turning to FIG. 5B, which depicts an example XML script to define a formula 5100 contains the same sample formula in line 5110. These show different methods of entering the same formula into the Behavior Compiler. The first by a Graphical User Interface means, and the second by XML scripting means.

Another example of a formula is Equation 1, which is the weighed sum of normalized values of all criteria. To do this, a weight will be associated with each criteria as shown in FIG. 2C. FIG. 2C depicts assignment of criteria when only three criteria have been selected. Understandably, more than tree criteria are preferably utilized, but three are shown for easier reader comprehension. One skilled in the art will appreciate utilizing additional criteria.

One skilled in the art will also appreciate that such weighting will assist strategic planners to specify the relative relation to the impact made by value of other criteria.

For example, as shown in FIG. 2C assume a Behavior Profile contains three criterions, wherein:

Criterion A 1210 is of some importance regarding indication of priority. Therefore, Criterion A 1210 is assigned the value of 100.

Criterion B 1220 is of less importance regarding indication of priority. While of less importance, extraordinary values of Criterion B should impact the resulting priority value. Therefore, Criterion B 1220 is assigned the value of 10.

Criterion C 1230 is of extreme importance regarding indication of priority. Even minor perturbations in its values should significantly impact the prioritization resultant. Therefore, Criterion C 1230 is assigned the value of 10,000.

For the above weighting scheme in the present example, values of Criterion A 1210 have ten times the impact on prioritization decisions as values for Criterion B 1220. Variation in values for Criterion C 1230 will have the greatest impact on the priority resultant. As a comparison, variations of Criterion C 1230 will have one hundred (100) times as much influence as equivalent variations of Criterion A 1210. Variations of Criterion C 1230 will have one thousand times (1000) as much influence as equivalent variations of Criterion B 1220.

### I.A.3. Activation of Criteria

As shown in FIG. 2A, once a criterion has gone through the steps of Defining 1100 and Weighting 1200, the criterion must under go the step of Activation 1300 before the mechanisms of the Autonomous Operation 2000 steps will consider values for it to compile numeric priorities. Activation 1300 results in immediate inclusion of the new criterion in the Behavioral Compilation 200 process.

### I.B. Autonomous Operations

As shown in FIG. 2A, Autonomous Operations 2000 consist of a cycle of three concurrent actions: (1) Collect Criteria Data 2100, (2) Compile Criteria Data 2200, and (3) Store Results 2300.

### I.B.1. Collection of Criteria

We now turn to FIG. 2D, which depicts an embodiment of the Autonomous Operation. While not explicitly shown in FIGS. 2A-2B, it is understood that step Define Criteria 1100 creates a list of the criterion defined.

As shown in FIG. 2D, this list is Criteria Defined 2130 and acts as a template for the data that must be collected for every Demand. The first step of the Autonomous Operations 2000 is to Collect Criterion Data 2100 for each criterion of each Demand from External Data Stores and record it in an internal data store as a part of Store Results 2300 step. Interfaces to various forms of data stores will vary from instance to instance and one skilled in the art will appreciate the mean to accommodate usage of various data formats.

### I.B.2. Compilation of Criteria Values

Continuing with FIG. 2D, we review this embodiment of Compilation Process 2100. The first step is Demand Received 2110 which then begins Compilation Process 2100.

From Criterion Defined 2130 listing, the first Selected Criterion Defined 2120 is accessed. For that particular criterion, a step 2140 of Retrieve Data for Criterion is performed. This data is typically retrieved from External Data Stores 2150. External Data Stores 2150 can be a plurality of data stores or a single store. Additionally, while it is preferred that these stores are external stores, internal stores may be used in conjunction with or in substitution of external stores.

Next, a decision step 2150 inquiring whether Data Retrieved for All Criterions is evaluated. If there are more criteria for which data has not yet been retrieved, then the next step is Select Criterion Defined 2120. The next criterion in Criterion Defined 2130 is preferably reviewed. This process repeats until all criteria to be evaluated are obtained, and decision step Data Retrieved for All Criterions 2150 is satisfied.

The values from the criterion data is then compiled in Compile Data 2210 step based on Equation Defined 2220. The step of Compile Data 2210 preferably provides the Priority level associated with the reviewed demand. The specific mathematical function in Equation Defined 2220 can vary from instance to instance.

One example equation embodiment that could be placed for a priority P in Equation Defined 2220 is Equation 1, as shown below. The present equation embodiment below is the weighted sum of normalized values:

$$P = \frac{{\sum }_{n} \frac{{v}_{n} {w}_{n}}{{u}_{n}}}{{\sum }_{n} {w}_{n}} \qquad Eq . 1$$

where:

P=The calculated Priority of a given Demand

vₙ=The current value associated with the n^{th} criterion for a given Demand

uₙ=The units associated with the n^{th} criterion for a given Demand

wₙ=The weight associated with the n^{th} criterion for a given Demand

The preceding example equation should not be viewed as a specification of mathematical requirements for function construction or practical usefulness.

Valid formulae can be any mathematical formula that the user can create to relate the various attributes together. The purpose of this formula is to allow the user to define the priority or importance of one demand versus another. The formula will be applied to all Demands.

### I.B.3Storage of Compilation Results

Upon completion of the Compile Data step 2210, the step of Record Data to Internal Data Stores 2310 is performed. The Priority value for the Demand is preferably recorded in Internal Data Stores 2320 which is preferably accessible to users of the Priority values.

### I.C. Summary of Behavior Profiler

Now, turning to 2E, which depicts another embodiment of the Behavior Profiler. Behavior Profiler 200, User Operations 1000 and Autonomous Operations 2000 work continuously and contemporaneously. It is important to understand that while User Operations 1000 initiate the aspects necessary to utilize the Autonomous Operations 2000, User Operations 1000 continues to operate, typically on an “as-needed” basis, while Autonomous Operations 2000 continues to run.

While it is instructive to view a process linearly, it is important to view the present invention as preferably a continuous, contemporaneous, on-going process that will allow for real time updates and reactions. In the following summary, criteria are reviewed. However, it is important to note that in the present invention, criterion and attribute can be used interchangeably.

Define Criteria 1100 can be viewed as having the first step 1150 for which the user is to Choose a Criteria. Then based on the criteria chosen by the user, the user completes the step 1160 of Provide a Criterion Identifier. Next step 1170 by the user is to Provide a Criterion Name. Then the user is to complete step 1180 of Provide a Criterion Unit. Then the user completes step 1190 of Provide a Criterion Source.

Step 1190 of Provide a Criterion Source is important so that the data for the criterion is noted and made available. One skilled in the art will appreciate that this data may come in many different forms and from many different means of transmission. Therefore, it is preferable that during the step of Provide a Criterion Source 1190 it includes providing means for reading the format of the data to be obtained for the particular criterion as well as the means for obtaining the data based on the need modes of transmission and/or communication. One skilled in the art will appreciate the variety of data and types of communication, as well as the necessary and available means for allowing such communication.

Following the step of Provide a Criterion Source 1190, during the initialization process it is preferable to have a decision step 1195 asking Have Another Criterion to Create.

Once the last criterion in the an addition process is created, the decision step asking the user if they Have Another Criterion to Create 1195 is satisfied, then the next steps are contained in Define Mathematical Formula 1200.

The next step 1250 is then defining a mathematical formula. This defining step can include selecting a weighting scheme followed by the step 1260 of Provide a Weight for Each Criteria. One skilled in the art will appreciate that this encompasses creation of an equation which satisfies both steps and that “weighted criteria” includes in the present invention creation of an equation which is capable of providing a priority for a demand based on the criteria provided.

The next step 1300 is to Activate New Criterion in the weighting process and/or equation.

Following this, within Collect Criteria Data 2100 the step 2190 essentially is just that, Collect Data for each Criterion. As discussed before, this is data collection for each activated criterion. While typically that data is collected for every criterion at the same time, other variations may include selection periods to collect data for certain criterions. For example, data for a certain criterion may need to be data collected in a real-time or near real-time manner. However, data collection for other criteria may be only necessary or even appropriate at certain periods, be it every minute, hour, day, week, year or variation thereof. Yet another variation to have the data collection source provide notice of a change of the data or “push” the data to the Behavior Profiler 200. This variation, of course, requires the appropriate configuration of the data source.

Following the step of Collect Criteria Data 2100 The step of Compile Priority Value 2290 is performed in the step of Compile Data 2200. As discussed prior, this is done by utilizing the weighting system and/or equation created in Define Mathematical Formula 1200.

Both steps of Collect Criteria Data 2100 and Compile Data 2200 pass the data associated with those steps to Store Results 2300, which preferably at a minimum includes the step of Store Compilation Values 2390.

It is important to note that following initialization the Autonomous Operations 2000 continue to run asynchronously, regardless of whether User Operation 1000 steps are being carried out. Additionally, it is not necessary to perform any of the steps of Define Criteria 1100 prior to performing Define Mathematical Formula 1200 following initialization.

A user may desire to modify the weighting system or equation and not add an additional criteria. Additionally a user may desired to delete a criteria. Following such modification or deletion, the step Activate New Criterion 1300 would be performed, and simply passed into the running Autonomous Operations 2000.

Other variation and combinations thereof of the interaction of User Operations 1000 and Autonomous Operations 2000 will be evident to one skilled in the art.

### I.D. Illustrative Example of Compilation Process of the First Example

A hypothetical linear view of an embodiment of the operational process of the Behavior Profiler 200 follows.

### I.D.1. 4.1 Assumptions

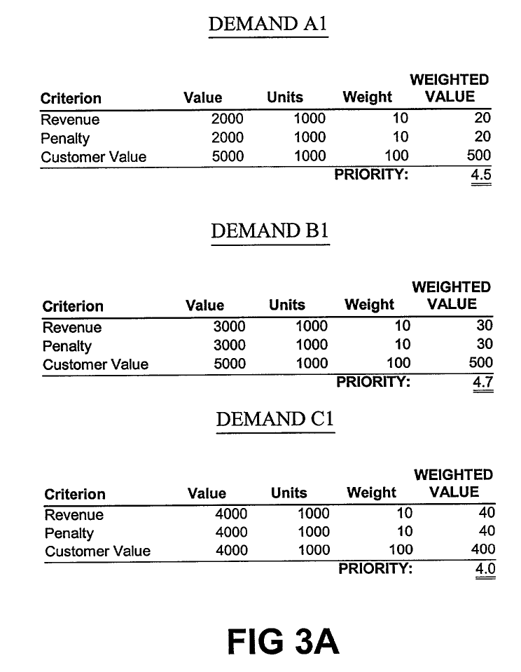

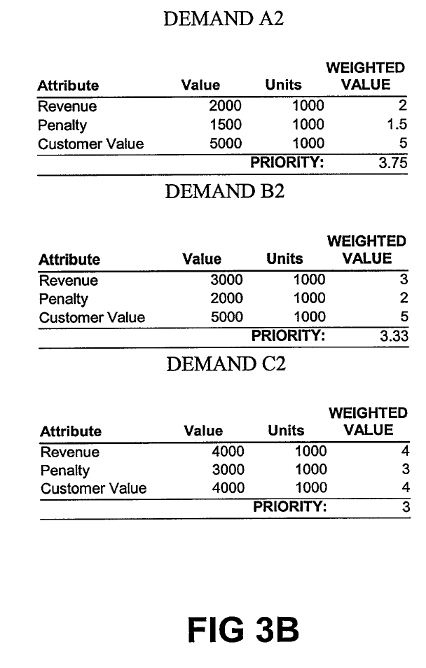

As shown in FIG. 3A, this present example considers the following assumptions to be made.

1) A network service provider owns a hypothetical network, which will be transporting the hypothetical Demands. Therefore, each Demand in this example is a service provided to a customer for a specified monthly fee.

2) The fiscal objective of the hypothetical network in this example is to generate revenue for the transportation of customer data. However there are expenses above and beyond the normal network costs which may or may not apply to the revenue stream. This includes penalties under a Service Level Agreement contract. These types of contracts were discussed prior in the Background section. Additionally there is a “customer value” that is provided which is the value the service provider associates to the particular customer.

3) Three Demands exist on the network: Demand A1, Demand B1, and Demand C1 .

a) Demand A1 is a service provided to customer X for a fee of $2000 per month. Violation of the Service Level Agreement will result in a penalty cost of $2000 to the Network Service Provider.

b) Demand B1 is a service provided to customer X for a fee of $3000 per month. Violation of the Service Level Agreement will result in a penalty cost of $3000 to the Network Service Provider.

c) Demand C is a service provided to customer Y for a fee of $4000 per month. Violation of the Service Level Agreement will result in a penalty cost of $4000 to the Network Service Provider.

### I.D.2. Collect Attributes

The above values stated in the three assumptions contain the values for each calculation.

### I.D.3. Compile Criteria Values into a Numeric Priority

The calculations are shown in FIG. 3A, where the value of each demand priority is 4.5 for Demand A1, 4.7 for Demand B1, and 4.0 for Demand C1.

Therefore with these priority values, Demands can be intelligently managed by a network routing systems which utilizes Demand priorities in calculating which Demands are ascribed a higher important than others. Therefore the Demands of higher importance or priority should be assured appropriate bandwidth in a network over Demands of lesser importance or priority.

### I.E. Second Illustrative Example of the Compilation Process I.E.1. Assumptions

As shown in FIG. 3B, this example considers the following assumptions:

1) A network service provider owns the hypothetical network, which will be transporting the hypothetical Demands. Therefore, each Demand in this example is a service provided to a customer for a specified monthly fee.

2) The fiscal objective of the hypothetical network in this example is to generate revenue for the transportation of customer data. However there are expenses above and beyond the normal network costs which may or may not apply to the revenue stream. This includes penalties under a Service Level Agreement contract. These types of contracts were discussed prior in the Background section. Additionally there is a “customer value” that is provided which is the value the service provider associates to the particular customer.

3) Three Demands exist on the network: Demand A2, Demand B2, and Demand C2.

a) Demand A2 is a service provided to customer X for a fee of $2000 per month. Violation of the Service Level Agreement will result in a penalty cost of $1500 to the Network Service Provider.

b) Demand B2 is a service provided to customer X for a fee of $3000 per month. Violation of the Service Level Agreement will result in a penalty cost of $2000 to the Network Service Provider.

c) Demand C2 is a service provided to customer Y for a fee of $4000 per month. Violation of the Service Level Agreement will result in a penalty cost of $3000 to the Network Service Provider.

4) Customer X contributes $5000 monthly revenue while customer Y contributes $4000 per month.

### I.E.2. Define Attributes

As discussed prior, attributes are equated with criterions in the present invention and should be view similarly. Valid business attributes can be any user defined, quantifiable business metric that can be directly associated with a given Demand. This example will use the following attributes:

### I.E.2.a) Demand Revenue

The monthly charge, measured in thousands of dollars, for providing a communication service between two predefined points.

### I.E.2.b) Demand Service Violation Penalty

A cost, measured in thousands of dollars, associated with violating thresholds of service performance that were established in a Service Level Agreement (SLA).

### I.E.2.c) Total Customer Revenue

The total revenue, measured in thousands of dollars, that is paid on a monthly basis by the customer associated with a particular Demand.

### I.E.3. Define Mathematical Formula

In this example, the formula is defined as shown in FIG. 4, in window 4110, as well as in FIG. 5, scripted line 5110. Specifically the formula is:

$$Prioity = \frac{Violation Penalty \times Total Customer Revenue}{Demand Revenue} \qquad Eq . 1$$

where:

Priority=The calculated Priority of a given Demand

Violation Penalty=The cost of a violation of the SLA in relation to the demand.

Total Customer Revenue=Total revenue received from the customer, include the contract relating to the present demand and any all other contacts.

Demand Revenue=The worth of the demand to the service provider in relation to all the customers of the provider.

### I.E.4. Collect Values for Criteria

The values stated in list item three of the assumptions above contain the values for each criterion.

### I.E.5. Compile Criteria Values into a Numeric Priority

The calculations are as shown in FIG. 3B. It should be observed that the results of the Behavioral Compilation place Demand A2 and Demand B2 at a higher Priority than Demand C2, even though the revenue and penalty for Demand C2 are greater than that of the other two. This is because the specific formula as shown in Equation 2, uses the Customer Value in it's calculation and the customer values of demand A2 and B2 are greater than the customer value of demand C2. This would likely be the result of a strategy to focus resources on satisfying top revenue customers.

A single customer may have more than a single SLA with a provider or may do additional business with the provider, in related and or unrelated areas of business. The value of the customer is the value given as a whole to the business done with the provider. This then allows an account manager to prioritize so that they may keep an important and/or large customer happy. One skilled in the art will appreciate the need to keep a customer happy.

### I.F. Exemplary Embodiment for Entry of Attributes or Criterion

One method for providing entry of data by the user in to the present invention is preferably a Graphical User Interface (“GUI”) window to allow easy addition, editing, and deletion of attributes/criterions.

For machine to machine transmission of attributes, it is preferably to send and receive them in XLM format.

Turning to FIG. 4a, we see a depiction of GUI device window to provide entry of attributes. Add Behavioral Profile Attribute Screen 4000 preferably contains Name Entry Window 4010 for which a name of an attribute can be entered. For example “demand_value” might be entered.

As discussed prior, valid attributes can be any user defined, quantifiable business metric that can be directly associated with a given Demand. FIG. 6 contains a sample list of potential attributes that may be of interest to business managers in making business decisions on the relative priority of Demands

Association Selection 4020 allows the attribute to be associated with a desired element through a pop-up list. In the present embodiment the default is a Demand. However any number of customer details might be desired. For example, the inherent customer value might be used. Other attributes not directly related to a Demand, might be of interest to a business manager and be added as an attribute/criterion.

Type Selection 4030 allows the attribute to be stored as a desired variable type through a pop-up list. In the present example, this includes single, double and floating.

Size Window 4040 allows for entry of the size of the variable associated with the attribute entered. For example, the present embodiment shows a size of “1000.”

Decimal Digits Data Entry Field 4050 allows for entry of the number of points to include in the data storage. In some cases excessive decimal points may utilize excessive memory and processing time. In the present embodiment “2” was entered.

Default Value Data Entry Field 4060 allows for entry of the “Default” value for the attribute. While typically this value of the attribute may default to zero, as in the present example, care must be taken to avoid a default value that will produce an unstable or undefined equation.

Add Attribute button 4080 will add the attribute to the profile, while Cancel button 4090 will clear the data from the Add Behavioral Profile Attribute Screen 2000.

As shown in FIG. 5a, Example of XML File to Define Attributes 5000 provides an example XML script of the Attributes defined. Script 5000 reflect the same entries as entered into Screen 4000.

### I.G. Exemplary Embodiment of Entry of Behavioral Profile Formula

The mathematical formula can be any multivariate function ƒ(a₁,a₂,a₃, . . . ,aₙ) that is applicable to each customer instance where aᵢ denotes the attribute i.

Preferably the formula is proprietary to the user of each system. The results of the application of the formula to the data collected for each attribute is the priority ranking in the importance of one demand in relations to other demands.

The formula can be defined manually using the system Graphical User Interface (GUI) or via an automatically generated Extended Markup Language (XML) file.

As shown in FIG. 4B, Behavioral Profile Formula Screen 4100 contains Current Formula window 4110. Formula Window 4110 displays the current behavior profile equation being utilized. Alternatively, as shown in FIG 5b, an XML Script 5100 depicts the same formula 5110. This is the same formula as shown in Formula Window 4110 but in a format that will aid in inter-computer communication of the script.

Attribute Selection Window 4120 preferably displays the attributes created with the Add Behavioral Profile Attribute Screen 4000. A user would select the desired attribute from Attribute Selection Window 4120 and use Entry Pad 4130 to create the formula.

One skilled in the art will appreciate that Entry Pad 4130 could contain additional elements to allow for any mathematical function that might be desired.

Save Button 4140 allows for saving of the equation into Behavioral Profiler 200 and immediate use. It is preferable that the equation be assigned a name upon a save function.

Clear Button 4150 allows for Formula Screen 4100 to be cleared.

Cancel Button 4160 cancels the current equation as shown in Equation Window 4110.

### II. Summary of the Exemplary Embodiment

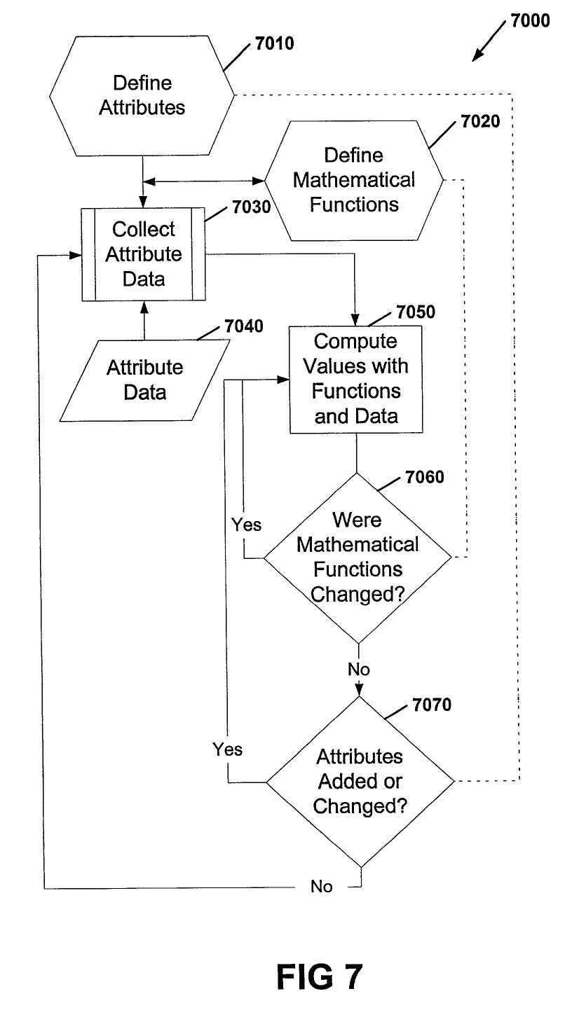

As shown in FIG. 7, Behavior Profile 7000 is a continuous process. The step of Define Attributes 7010 is tied to the decision step Attributes Added or Changed 7070 as when an attribute is added or changed then step Compute Values 7050 is performed.

Similarly the step of Define Mathematical Functions 7020 is tied to the decision step Were Mathematical Functions Changed 7060. When changes occur do to activity of Define Mathematical Functions 7020, step 7050 Compute Values is performed. Step 7050 computes the Priority value based on the mathematical function defined which utilized the attributes which are preferably weighted. This Priority can then be used to determine the relative “value” or “priority” of a demand on a network. From this the user of the system can instruct, on demand or automatically, a router can appropriately route to demand or delay or drop the demand based on this priority value.

Additionally step 7050 Compute Values is performed to account for changes of data, sent by step Collect Attribute Data 7030. While it is preferably to collect data frequently, if not constantly, it is possible to assign a certain frequency of the collection period or trigger a collection when Attribute Data 7040 changes.

Attribute Data 7040 may be collected from a single source or multiple sources. Additionally, each individual attribute may have separate collection times depending on the design of the collection system.

The preceding embodiments are given by way of example only, and not by way of limitation to the invention. The true essence and spirit of this invention are defined in the appended claims, and is not intended that the embodiment of the invention preceding should limit the scope thereof. It will be appreciated that the present invention can take many forms and embodiments. Variations and combinations thereof evident to one skilled in the art will be included within the invention defined by the claims.

What is claimed is:

1. The method providing a priority value for a demand comprising the steps of:
selecting a plurality of business attributes;
creating a user defined mathematical formula based on the attributes, wherein the formula provides relative values coinciding with the importance of demands;
collection of value data related to the attributes;
calculating a business priority for a demand based the formula and the data collected.

2. The method of claim 1 further comprising the step of:
storing the priority value in a database.

3. The method of claim 2 further comprising the step of:
operatively connecting the database with a network management system.

4. The method of claim 1 wherein the demand is:
a requirement for a certain amount of bandwidth to be reserved between an originating and a terminating node in a network.

5. The method of claim 4 wherein the network is:
a digital network which is operatively connected to the Internet.

6. The method of claim 1 wherein the collection of data comprises an asynchronous automated data collection system.

7. The method of determining a relative business value for a demand comprising the steps of:
selecting a plurality of business attributes;
collection of data related to the attributes; and
calculating the relative business value based on the data collected.

8. The method of claim 7 wherein,
the step of calculating the relative business value utilizes is based on a single equation

9. The method of claim 8 wherein,
the equation is a function a plurality of the attributes.

10. The method of claim 8 wherein,
the equation is a function of the attributes.

11. The method of claim 8 wherein
the equation provides weighting of the attributes in relation to the revenue of a network.

12. The method of prioritizing network traffic comprising the steps of:
user selection of a plurality of business attributes;
user creation of a defined mathematical formula based on the attributes to calculate relative priorities of demands;
automated collection of data related to the current value of the business attributes; and
automated calculation of a priority values.

13. The method of claim 12 further comprising the step of:
storing priority values in digital memory.

14. The method of claim 12 further comprising the step of:
recursively performing the automated steps.

15. The method of claim 14 further comprising the step of:
asynchronously performing the user step of attribute selection

16. The method of claim 15 further comprising the step of:
asynchronously performing the user step of formula creation.

17. The method of claim 14 further comprising the step of:
asynchronously performing the user step of formula creation.

18. The method of claim 12 wherein the user steps, are an initialization step.

19. The method of claim 18 wherein the steps run asynchronously following the initialization step.

20. The method of claim 18 wherein the automated steps run asynchronously following the initialization step.
